(19) United States
(12) Patent Application Publication
(10) Pub. No.: US 2009/0084622 A1
(43) Pub. Date: Apr. 2, 2009

(54) Method of Mass Transit

(76) Inventor: John K. Donovan, Alexandria, VA (US)

Correspondence Address: MICHAEL RIES, 318 PARKER PLACE, OSWEGO, IL, 60543, US

(21) Appl. No.: 12/240,730

(22) Filed: Sep. 29, 2008

Related U.S. Application Data
(60) Provisional application No. 60/976,736, filed on Oct. 1, 2007.

(51) Int. Cl. B60V 1/00

(52) U.S. Cl. 180/116

(57) ABSTRACT

Disclosed is a method for converting the area of federally protected wetlands, like those located between the Anacostia River's edge and the boundary of the Washington Metropolitan Area Transit Authority's (WMATA) Anacostia Metrorail Station's property line, into a right-of-way or a specific travel route for the safe passage of hovercraft passenger ferry that is non-destructive of the environmentally sensitive nature of the land used as a right-of-way.

This application claims priority to U.S. Provisional Application 60/976,736 filed 1 Oct. 2007, the entire disclosure of which is incorporated by reference.

### TECHNICAL FIELD AND BACKGROUND

The present invention relates to a method for converting federal, state, or local government designated protected wetlands; Critical Watershed Areas; and/or land located between the water's edge of a navigable waterway and any inner boundary set by government law or regulation that delineates the landside limit of an area of land designated as environmentally sensitive which is established in order to protect the quality of a water feature (i.e. river, stream, lake, etc.) bordered by the water's edge and the maximum limit of the designated property from run-off of pollutants by rain water, farming, storm fun-off, etc. For example, the State of Maryland has established a Critical Watershed Area (CWA) on every navigable waterway that extends from the water's edge to 1,000 feet inland. The zone of land thus delineated in one where economic development of the property is significantly constrained by law or regulation that increases the cost of development, or completely removes the potential economic benefit of developing the property for commercial or residential use altogether; and turning this area into safe passage of a hovercraft passenger ferry. More specifically, the present invention is a method for converting area of federal, state or local government protected wetlands, or other government designation that sets land aside from real estate development due to the land's area, bounded by a navigable waterway and a distance inland from the waterway set by a governing authority, that is established by law or regulation in order to protect the quality of the water of the navigable waterway from pollutants produced in any form on the land so designated, into a right-of-way or a specific travel route for the safe, non-destructive, passage of hovercraft passenger ferry, or freight hovercraft.

The present invention is a method that allows vessels direct, intermodal transfer of ferry passengers or freight between various hovercraft passenger ferry vessels and the pedestrian entrance of planned or established mass transit terminals, locations, or train, rail, subway or metrorail stations, while maintaining the protected wetlands, or designated areas as open greenways suitable as parkland when not in use by passenger hovercraft vessels in order to conform with Federal, State or Local laws or regulations regarding the designated areas which have had their economic utility damaged or reduced by virtue of their designation as necessary to the protection of the quality of the water in the navigable waterway. The present invention includes all critical watershed areas or other environmentally sensitive areas, bordering public waterways on which development is restricted by law or regulation in order to prevent water runoff from carrying pollutants of any type into the waterway or adjacent body of water, by providing use of the designated land as a for hire right-of-way for the passage of hovercraft carrying passengers or freight by restoring lost economic benefit to the owner of the land in question and by lowering the cost of providing mass transit access to land suitable for commercial or residential development, but isolated by virtue of the fact the area between the development suitable land is restricted to non-destructive use—the passage of hovercraft for hire over a right-of-way being a new, non-destructive use to which the designated land can utilized.

In one embodiment, the present invention will make it possible for the most efficient movement of large numbers of passengers, 4,000-6,000 per day, from one mode of travel, Passenger Ferry—Hovercraft, to another mode of travel, MetroRail, to facilitate the mass transit movement of individuals living 10-30 miles outside of Washington, D.C., to and from their places of employment in Washington, D.C. proper. The present invention eliminates the need for an intervening shuttle bus service to move passengers from the water's edge to the nearest Metrorail station, a distance of approximately 1400-feet. Prior market studies indicate that any ferry service that requires an intervening passenger shuttle service will not be commercially viable due to the added inconvenience of an extra travel-mode change. In this embodiment, by passing over the area of the protected federal wetlands at Poplar Point along the Anacostia River, without damaging the wetlands, the present invention will solve the single greatest obstacle to a successful Passenger Ferry Service serving residents of Virginia and Maryland as they commute to jobs in our nation's capital.

In the last 40-years the area Departments of Transportation and private enterprise have tried to find a way to make the Potomac and Anacostia Rivers a route of passenger travel for the 300,000-plus commuters to D.C. from Virginia and Maryland. Due to the distance between the river's edge and Metrorail stations it was not believed possible in Washington, D.C. In addition, federal laws and regulation dictate that the area remain green/wetland (i.e. no paved roads or parking lots, and no buildings may be erected in the area described. The invention includes a combination of regularly scheduled passenger-hovercraft operations using a route that passes in a non-destructive manner over this specific and particular geographic area in Washington, D.C. that allows the geographic area to remain as federal law and regulation dictates, but at the same time be available as a right-of-way, for which the owner or owners can charge a fee and recover an economic benefit from using the area in the cited embodiment in the manner described.

This particular and unique ferry route is needed for the proper operation of a public, or private, high-speed commuter ferry service for Virginia and Maryland suburban residents to provide a direct intermodal connection with Washington, D.C.'s urban mass transit services known as the Metrorail System.

The only way to connect directly between a vessel and a pedestrian entrance of a Metrorail station is to have the vessel unload and load passengers within a 100-ft. or so of the Metro station. Commuters are too busy to walk the great distances between the river's edge and the station, and market surveys have indicated Commuters will not tolerate having additional travel modes added to their existing commutes (i.e. they are too busy to sit through an intervening trip from a water's edge ferry landing to a Metrorail station aboard a shuttle bus).

The embodiment of the present invention of combining the shuttle bus role with the passenger vessel role by passing over federally protected wetlands at Poplar Point adjacent to the Anacostia Metrorail Station cannot currently be achieved in an economical manner. The method includes 1. U.S. Coast Guard approved passenger ferries—hovercraft. 2. Low-lying, federally protected wetlands at Poplar Point in Washington, D.C. that lies between the river's edge and the nearest boundary of WMATA property adjacent to said wetlands and the pedestrian entrance of said WMATA station named Anacostia Metrorail Station. This geographic area cannot be built on and will be maintained as a low lying environmental sensitive area that will have standing water from time to time during the year. 3. A pad constructed of concrete, or a similar hard material suitable for supporting the weight of a hovercraft resting on it, on public or WMATA property for the actual touchdown of hovercraft for the loading and unloading of passengers and any associated buildings for passenger comfort.

### BRIEF DESCRIPTION OF THE DRAWINGS

The objects, features, and advantages of the present invention will be apparent from the following detailed description of the preferred embodiment of the invention with references to the following drawings.

FIG. 1 is a drawing of method of using mass transit with a hovercraft of one embodiment of the present invention.

FIG. 2 is a drawing of method of using mass transit with a hovercraft of one embodiment of the present invention.

FIG. 3 is a drawing of method of using mass transit with a hovercraft of one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

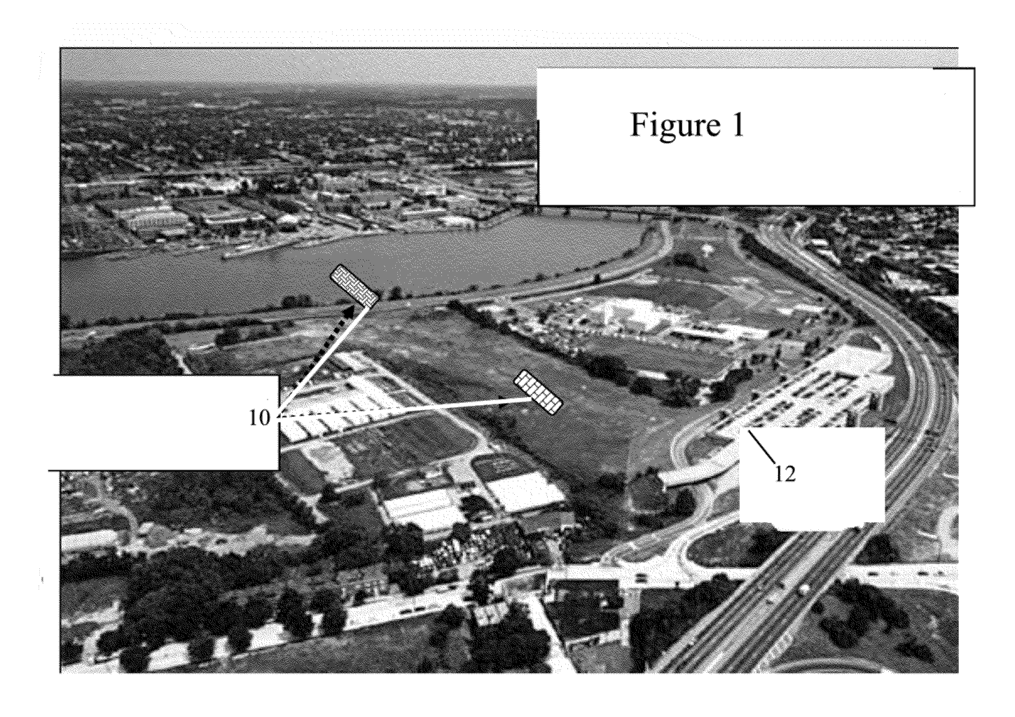

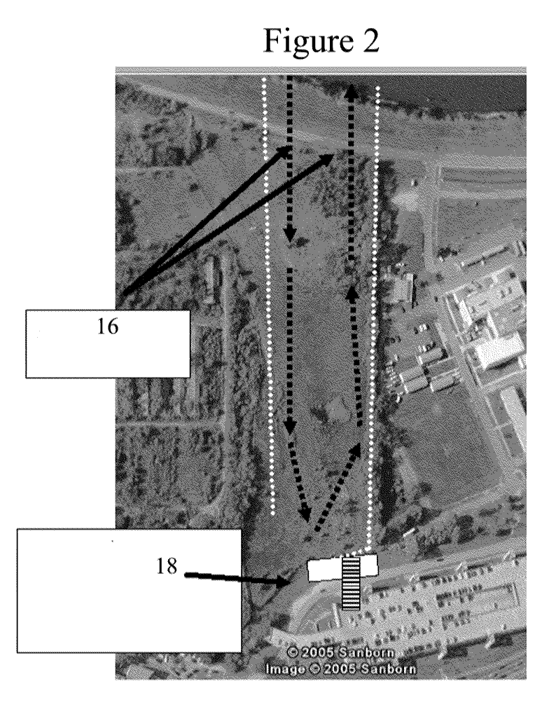

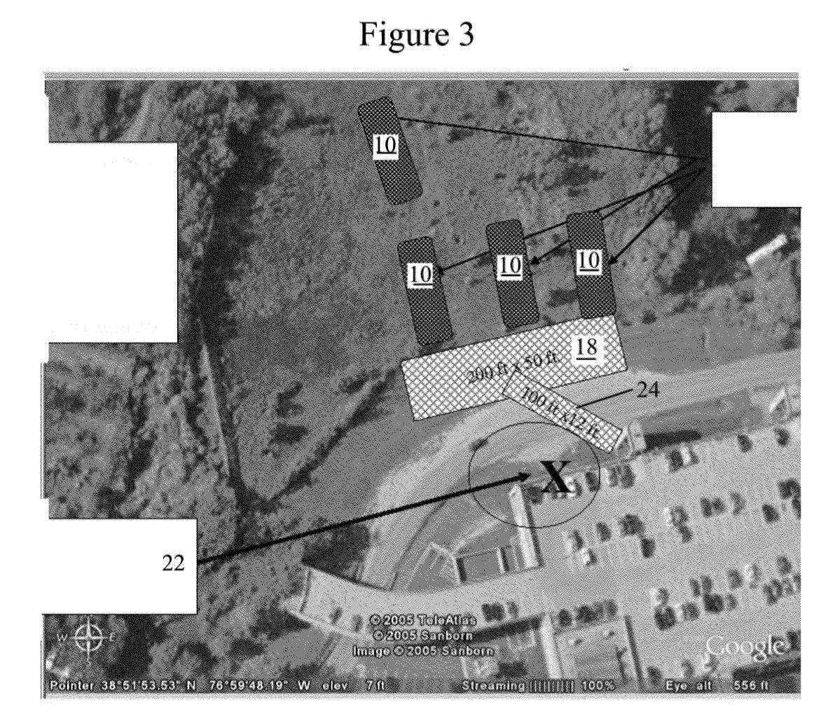

Referring to FIG. 1, as in one embodiment is a drawing of top view of Anacostia metro station area with metro entrance 12. Show are hovercraft 10 traveling over federally protected wetlands at Poplar Point. In FIG. 2 as in one embodiment shown are hovercraft crossing gates 16 and hovercraft terminal 18. In FIG. 3 as in one embodiment shown is hovercraft 10 at a hovercraft terminal 18. A pedestrian bridge 24 connects hovercraft terminal 18 to a metro entrance 22. The hovercraft terminal 18 may be two hundred by 50 feet. The pedestrian bridge 24 may be one hundred by twelve feet.

The present invention as in one embodiment is a high speed water taxi route using small, 12 or so passenger hovercraft to carry 6-passengers at a time from the vicinity of National Harbor—a new entertainment development in Prince George's County, MD to the vicinity of Ronald Reagan National Airport, and vice versa—for the purpose of the rapid movement of travelers between the two locations without delays due to traffic. The method is to combine several elements to provide the quickest, easiest transit for passengers between these two major transportation destinations—National Harbor and Reagan National Airport—that are located approximately 3 miles apart as the crow flies on opposite banks of the Potomac River. U.S. provisional patent 60/978,138 filed Oct. 8, 2007 the entire disclosure of which is incorporated by reference

When users want a travel experience similar to the well accepted “from home by car to bus/train station to Metro” sequence of travel, and, 2. An extra mode (i.e. a shuttle bus—even a free one) is what the market survey called a “deal killer.” . . . were not too negative. A careful reading of the VDOT 2000 Study shows that the authors believed a shuttle bus service would be needed at each and every location where a ferry discharged passengers. By using Hovercraft in the manner I described at Anacostia Metro, this need is eliminated and the user is given the “from home by car to bus/train station to Metro” sequence of travel they currently accept. By building an “In Fill” Metro Station just North of Four Mile Run a Hovercraft Ferry Service would have two direct transfer points with Metro (one on the Blue/Yellow Line and one on the Green Line) while providing a location for vessels to bring in passengers from National Harbor directly to Reagan National Airport. The Pentagon Bus—Metro direct transfer station handles 35,000 users per day because of the direct connection.

The 1st elements are the two locations. National Harbor (NH) is a new, 2,000 room entertainment and convention center located on the shore of the Potomac River near Oxon Hill Rd, Prince George's County, Maryland. NH has very limited mass transit with none connecting directly to either Washington, D.C.'s Metrorail system, or another system capable of taking passengers directly from NH to the nearest major airport, Reagan National Airport, without either multiple travel mode changes, or travel by congested roadways. Reagan National Airport is a favorite arrival terminus for travelers to Washington, D.C.'s and the closest to National Harbor. Existing routes are between the two locations are either a 17 mile trip by car or motor coach through Washington, D.C., or a 5 mile trip car or motor coach through crowded Alexandria, Va. with multiple traffic light delays. Both routes are very congested with travel times up to 1 hour one-way via either route during rush hour traffic.

The second element is to use small, multi-passenger hovercraft, of either U.S. or Foreign Construction, to carry no more than 6 paying passengers at a time directly along a 3 mile route between National Harbor and RNA. The use of hovercraft ensures that service between NH and RNA can continue despite debris filling the river in spring time, or ice blocking the river in winter time. In addition, there will never be a traffic tie-up on the river. The travel time between NH to RNA or from RNA to NH will be approximately 10 minutes at all times, and in all weather.

The third element will be to use U.S. Coast Guard approved pilots to safely and efficiently operate the vessels between the two locations where the pilots will have the US Coast Guard License entitled “OPERATOR OF UNINSPECTED PASSENGER VESSELS ALL ROUTES”. These USCG approved pilots will ensure they never carry more than the allotted 6 passengers per trip.

The fourth element will be a landing adjacent to Reagan National Airport that will allow the loading and unloading of passengers and luggage along one of the airport perimeter roads so that passengers can easily board airport parking shuttle for transfer to/from the appropriate terminal.

By using Junior Water Line Metro, the traveler will have only one travel mode transfer (airport parking shuttle to hovercraft) and a much more efficient trip. Another travel mode that will be available between NH and RNA will be Potomac Riverboat Company's vessels. These displacement hull vessels travel more slowly and make landfall in downtown Alexandria, Va. where the traveler will then have to transfer to a taxi or motor coach for the 3 mile trip to RNA. Alternatively, the Potomac Riverboat user could take the free Alexandria City motor coach from the boat landing to the Metrorail station on King Street and then take Metro to the Reagan National Airport Metrorail station to arrive at the airport.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method comprising:
providing a pad comprised of construction material on public property for an actual touchdown of a hovercraft for loading and unloading of passengers and any associated buildings for passenger comfort; and
transporting the passengers over low-lying, federally protected wetlands at Poplar Point in Washington, D.C. that lies between the river's edge and the nearest boundary of WMATA property adjacent to wetlands and the pedestrian entrance of said WMATA station named Anacostia Metrorail Station, this geographic area cannot be built on and will be maintained as a low-lying area that will have standing water from time to time during the year.

2. The method of claim 1 wherein the pad is on WMATA property.

3. The method of claim 1 wherein crossing gates for the hovercraft are placed at roadways.

4. The method of claim 1 wherein hovercraft terminal is near Anacostia Metrorail Station.

5. The method of claim 1 wherein a pedestrian bridge connects the hovercraft terminal to a metro entrance.

6. The method of claim 5 wherein the hovercraft terminal is two hundred by fifty feet.

7. The method of claim 5 wherein the pedestrian bridge is one hundred by twelve feet.

8. A method comprising:
providing a multi-passenger hovercraft; and
driving the multi-passenger hovercraft over protected wetlands to provide mass transit.

9. The method of claim 8 wherein the multi-passenger hovercraft carries no more than 6 paying passengers.

10. The method of claim 8 wherein the multi-passenger hovercraft follows a 3 mile route between National Harbor and RNA.

11. The method of claim 8 wherein the use of hovercraft ensures that service between NH and RNA can continue despite debris filling the river in spring time or ice blocking the river in winter time.

12. The method of claim 8 wherein a travel time between NH to RNA or from RNA to NH will be approximately 10 minutes at all times and in all weather.

13. The method of claim 8 wherein driving will be by U.S. Coast Guard approved pilots to safely and efficiently operate the vessels between the two locations where the pilots will have the US Coast Guard License entitled OPERATOR OF UNINSPECTED PASSENGER VESSELS ALL ROUTES, these USCG approved pilots will ensure they never carry more than the allotted 6 passengers per trip.

14. The method of claim 8 wherein a landing for the multi-passenger hovercraft adjacent to Reagan National Airport that will allow the loading and unloading of passengers and luggage along one of the airport perimeter roads so that passengers can easily board airport parking shuttle for transfer to/from the appropriate terminal.
